(19) United States
(12) Patent Application Publication
(10) Pub. No.: US 2005/0019030 A1
(43) Pub. Date: Jan. 27, 2005

(54) Lens system

(76) Inventors: Tadashi Sasaki, Saitama-shi (JP); Atsushi Kanayama, Saitama-shi (JP)

Correspondence Address: HARNESS, DICKEY & PIERCE, P.L.C., P.O. BOX 8910, RESTON, VA, 20195, US

(21) Appl. No.: 10/897,111

(22) Filed: Jul. 23, 2004

(30) Foreign Application Priority Data
Jul. 23, 2003 (JP) 2003-278335

(51) Int. Cl. G03B 17/00

(52) U.S. Cl. 396/300

(57) ABSTRACT

A drive unit is installed in, for example, a manually operated cinema photographing lens and connected to a system controller so that the system controller can electrically control the focus, zoom, and iris of the photographing lens. When a select switch of the system controller or a PC is used to specify the type of the photographing lens, the system controller executes a process adapted to the type of the photographing lens.

### BACKGROUND OF THE INVENTION

1. Field of the Invention

The present invention relates to a lens system, and in particular, to a lens system suitable for film making.

2. Description of the Related Art

Some photographing lenses for television broadcasting or cinema photographing (cinemas) integrally comprise a control device composed of a motor, a position sensor, a control circuit, and the like to electrically drivingly control a focus, a zoom, and an iris. Other such photographing lenses do not comprise any control devices. In general, many photographing lenses for television broadcasting comprise a control device. However, many photographing lenses for cinemas lack a control device because they are essentially manually operated, that is, they are manually driven.

Japanese Patent Application Publication No. 2003-149541 describes a lens system.

### SUMMARY OF THE INVENTION

In recent years, there has been an increasing demand for the electric operation of photographing lenses instead of manual operation in the field of cinema photographing. More and more requests have been made for accessories that enable the electric driving control of photographing lenses that do not come standard with a control device. However, the problems below must be solved before such a system can be constructed using an accessory.

A control device provided in a standard photographing lens is designed to properly control the photographing lens because only the photographing lens is to be controlled. For example, when the focus, zoom, or iris is controlled, a detector detects the position of the corresponding lens and the corresponding motor is driven with reference to an output value from the detector. However, if this control device is used in a different type of photographing lens as it is, the photographing lens is not appropriately controlled because the range of output values from the position detector does not conform to this photographing lens and because this photographing lens has different characteristics and performance.

Accordingly, if a system is constructed which enables a photographing lens not provided with any control devices to be electrically drivingly controlled using an accessory, measures must be taken to allow the accessory to properly process various types of photographing lenses instead of a particular photographing lens because the accessory must be able to be used for general purposes.

In cinema photographing, not only videos but also information on the videos are commonly recorded. This information is called meta data and includes not only camera information but also information on a photographing lens which indicates set conditions for the photographing lens such as an lens-to-subject distance, a focal distance, and an iris value.

It is convenient to be able to automatically acquire meta data, record it in a recording medium together with videos, and reproduce it from the recording medium. However, as described above, since many cinema photographing lens are essentially manually operated and are not provided with a position detector or the like, an accessory must be used in order to achieve the above object for the cinema photographing lens. Also in this case, meta data such as the lens-to-subject distance, the focal distance, and the iris value may not correctly determined if an attempt is made to execute exactly the same process on a different type of photographing lens to determine the meta data from values for the focus, zoom, and iris which are outputted by the position detector. Thus, to allow the same accessory to be used for various cinema photographing lenses, measures must be taken to adapt it to these photographing lenses.

In view of these circumstances, it is an object of the present invention to provide a lens system that allows an accessory to be adapted to various photographing lenses, the accessory enabling a photographing lens to be electrically driving controlled.

To accomplish the above object, a first aspect of the present invention provides a lens system comprising an accessory which electrically controls a photographing lens of a camera and which executes a process using inherent data inherent in the photographing lens, and an inherent data setting device which sets, in the accessory, the inherent data used for the photographing lens.

According to a second aspect of the present invention, the lens system according to the first aspect is characterized in that the accessory uses the inherent data set by the inherent data setting device, to generate meta data indicating set conditions for the photographing lens.

According to a third aspect of the present invention, the lens system according to the first or second aspect is characterized by comprising individuality information setting device for setting individuality information specifying the individuality of the photographing lens, in the accessory.

According to a fourth aspect of the present invention, the lens system according to the first or second aspect is characterized in that the accessory pre-stores individuality-wise inherent data corresponding to a plurality of photographing lenses having different individualities, and the inherent data setting device selects the inherent data used for the photographing lens to be controlled, from the individuality-wise inherent data stored in the accessory.

According to a fifth aspect of the present invention, the lens system according to the fourth aspect is characterized by comprising input device for communicatively inputting inherent data to be stored in the accessory, to the accessory.

According to a sixth aspect of the present invention, the lens system according to the first or second aspect is characterized in that the inherent data setting device comprises input device for communicatively inputting the inherent data used for the photographing lens to the accessory.

According to a seventh aspect of the present invention, the lens system according to the fourth or fifth aspect is characterized by comprising individuality information setting device for setting individuality information specifying the individuality of the photographing lens, and the inherent data setting device selects inherent data corresponding to the photographing lens specified by the individuality information, from the individuality-wise inherent data, on the basis of the individuality information set by the individuality information setting device.

According to an eighth aspect of the present invention, the lens system according to the third or seventh aspect is characterized in that the individuality information is a type or serial number of the photographing lens.

According to a ninth aspect of the present invention, the lens system according to the third, seventh, or eighth aspect is characterized in that the accessory transmits the individuality information set by the individuality information setting device to a communicatively connected predetermined processing device in response to a transmission request from the processing device when the processing device is initialized, and if the individuality information setting device changes the individuality information after the initialization, the accessory urges the processing device to request retransmission of the individuality information and retransmits the changed individuality information to the processing device in response to the transmission request.

According to a tenth aspect of the present invention, the lens system according to the ninth aspect is characterized in that the accessory urges the processing device to request retransmission of the individuality information by causing an error in communication with the processing device.

According to an eleventh aspect of the present invention, the lens system according to the ninth or tenth aspect is characterized in that the processing device is the camera, or a meta data recording device in which meta data is recorded, the meta data being generated using the inherent data set by the inherent data setting device and indicating the set conditions for the photographing lens.

With the lens system according to the present invention, the accessory electrically drivingly controlling the photographing lens executes a process using the inherent data inherent in the photographing lens. It is also possible to set inherent data adapted to the photographing lens to be controlled. Accordingly, the accessory is applicable to various photographing lenses. Furthermore, if the accessory is used to generate meta data such as the lens-to-subject distance, the focal distance, and the iris value, for applications such as cinema photographing, it can be adapted to various photographing lenses.

### BRIEF DESCRIPTION OF THE DRAWINGS

FIG. 1 is a block diagram showing the configuration of, for example, a cinema photographing system in which the present invention is implemented;

FIG. 2 is a block diagram showing the configuration of a system controller;

FIG. 3 is a flow chart showing a process procedure executed by a CPU of the system controller; and

FIG. 4 is a flow chart showing a process procedure executed by the CPU of the system controller according to another embodiment.

### DETAILED DESCRIPTION OF THE PREFERRED EMBODIMENTS

With reference to the attached drawings, description will be given of a preferred embodiment of a lens system according to the present invention.

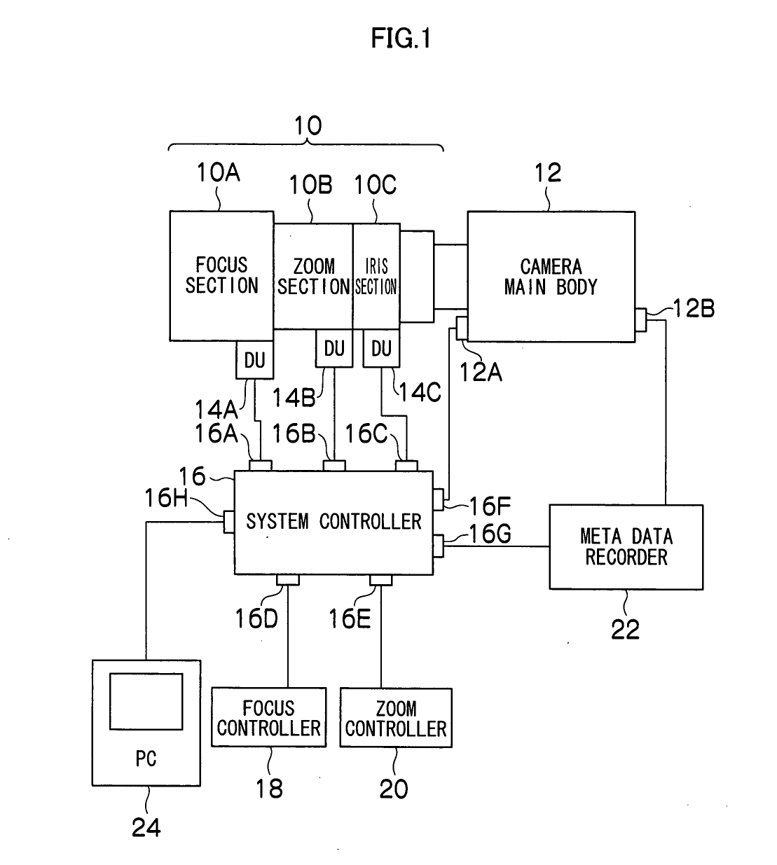

FIG. 1 is a block diagram showing the configuration of, for example, a cinema photographing system to which the present invention is applied. In this figure, a photographing lens (optical system) 10 is installed by being mounted in a camera main body 12 provided with a photographing element, a video signal processing circuit, and the like. The photographing lens 10 is divided into a focus section 10A, a zoom section 10B, an iris section 10C, and the like in association with the type of a movable optical part placed in a barrel. A focus lens (a group of focus lenses) is placed in the focus section 10A; the focus lens is driven in the direction of an optical axis mainly to focus on an object. A zoom lens (a group of zoom lenses) is placed in the zoom section 10B; the zoom lens is driven in the direction of the optical axis to change the focal distance of the photographing lens 10. An iris is disposed in the iris section 10C.

On the other hand, drive units 14A to 14C are installed in the barrel of the photographing lens 10. For example, a focus ring, zoom ring, and iris ring which are rotatively movable are disposed around the periphery of the barrel of the photographing lens 10. The photographing lens is of a type in which these operation rings are rotatively moved to manually (by force) drive the focus lens, the zoom lens, and the iris. That is, in a standard form, the photographing lens is not provided with any devices allowing the focus lens, the zoom lens, and the iris to be electrically driven. The focus lens, the zoom lens, and the iris can be electrically driven by installing the drive units 14A to 14C at predetermined positions of the barrel of the photographing lens 10 as shown in the figure and engaging motors for the drive units 14A to 14C with the respective operation rings.

A system controller 16 in the figure is an interface accessory (an accessory) which electrically controls mainly the focus lens, zoom lens, and the iris of the photographing lens 10 via the drive units 14A to 14C and which generates meta data, described later. The drive units 14A, 14B, and 14C are connected to terminals 16A, 16B, and 16C, respectively, of the system controller 16 via cables. Further, a focus controller 18 and a zoom controller 20 are connected to system controllers 16D and 16E, respectively, to allow an operator to manually remotely control the focus or zoom via cables.

A control terminal 12A of a camera main body 12 through which a power supply and various signals are transmitted and received is connected to a terminal 16F of the system controller 16 via a cable. A meta data recorder 22 that records video signals and meta data in a recording medium (a tape, a semiconductor recording medium, or the like) is connected to a terminal 16G via a cable. A video signal output terminal 12B of the camera main body 12 is connected to the meta data recorder 22. Thus, the photographing lens 10 forms an image, which is then photoelectrically converted by an image pickup element of the camera main body 12 into a video signal. The video signal is then provided to the meta data recorder 22.

A data input device that communicates various data can be connected to a terminal 16H of the system controller 16 via a cable. In this figure, a personal computer (PC) 24 is connected as the data input device.

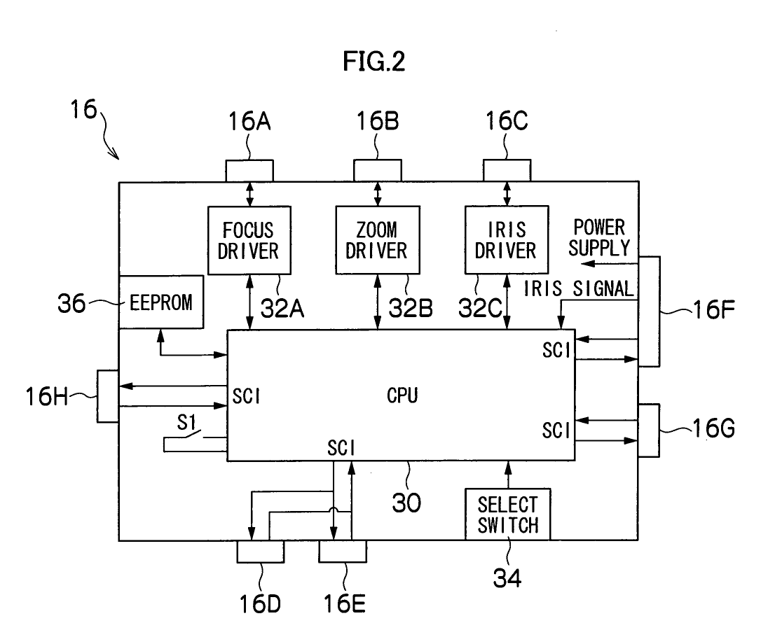

FIG. 2 is a block diagram showing the configuration of the system controller 16. As shown in this figure, the system controller 16 has a built-in CPU 30 that integrally executes various processes.

A focus driver circuit 32A, a zoom driver circuit 32B, an iris driver circuit 32C are connected to the respective drive units 14A, 14B, and 14C via the respective terminals 16A, 16B, and 16C. The CPU 30 provides control signals to the drive circuits 32A to 32C so that the motors for the drive units 14A to 14C are driven by the respective driver circuits 32A to 32C on the basis of the control signals. Accordingly, the focus lens, zoom lens, and iris of the photographing lens 10 are electrically driven by control signals from the CPU 30.

The drive units 14A to 14C are provided with potentiometers that detect the positions of the focus lens, zoom lens, and iris, respectively. Output values from the potentiometers are read by the CPU 30 via the respective driver circuits 32A to 32C.

A serial communication interface (SCI) built into the CPU 30 is used to transmit various signals between the CPU 30 and both focus controller 18 and zoom controller 20, connected to the respective terminals 16D and 16E of the system controller 16. One of the manual operation members provided in the focus controller 18 and zoom controller 20, respectively, is operated and the corresponding controller 18 or 20 transmits an instruction signal corresponding to the operation. Then, on the basis of the instruction signal, the CPU 30 outputs control signals to the focus driver circuit 32A or the zoom driver circuit 32B to drive the focus lens or the zoom lens, respectively. Thus, manual operation of the focus controller 18 or zoom controller 20 allows the focus lens or zoom lens of the photographing lens 10 to be electrically driven. It is also possible to allow the iris to be manually operated using a controller.

The control terminal 12A of the camera main body 12, connected to the terminal 16F of the system controller 16, provides a power supply and an instruction signal (iris signal) that automatically controls the iris. The CPU 30 acquires the iris signal and outputs a drive signal to an iris driver circuit 32C to drive the iris on the basis of the iris signal. Thus, the iris signal causes the iris of the photographing lens 10 to be electrically driven. Further, the CPU 30 uses the SCI to transmit and receive various signals to and from the camera main body 12 through the control terminal 12A of the camera main body 12.

The SCI, built into the CPU 30, is used to transmit various signals between the CPU 30 and the meta data recorder 22, connected to the terminal 16G of the system controller 16. Thus, the CPU 30 transmits meta data to the meta data recorder 22. Information transmitted as meta data includes information indicative of set conditions for the camera main body 12 and information such as an lens-to-subject distance, a focal distance, and an iris value which is indicative of set conditions for the photographing lens 10. No detailed descriptions will be given of the information in the meta data which is indicative of the set conditions for the camera main body 12. The CPU 30 acquires the information indicative of the set conditions for the camera main body 12, from the camera main body 12 through communications with the control terminal 12A of the camera main body 12. The CPU 30 then transmits the information to the meta data recorder 22 as meta data.

The lens-to-subject distance, contained in the meta data indicative of the set conditions for the photographing lens 10, is determined on the basis of a value outputted by the potentiometer of the drive unit 14A as the current position of the focus lens. The focal distance is determined on the basis of a value outputted by the potentiometer of the drive unit 14B as the current position of the zoom lens. The iris value is determined on the basis of a value outputted by the potentiometer of the drive unit 14C as the current position of the iris (or output values from the potentiometers for the zoom lens and iris). The thus determined lens-to-subject distance, focal distance, and iris value are transmitted to the meta data recorder 22 as meta data. The meta data is generated, for example, for each frame of a video signal and transmitted for each frame of the video signal in response to a transmission request from the meta data recorder 22. Alternatively, the meta data may be sequentially transmitted at specified time intervals or may be transmitted when its contents are changed.

The meta data recorder 22 records meta data received from the CPU 30 of the system controller 16, in the recording medium in association with video signals acquired from the camera main body 12. The video signals and the meta data may be recorded in the same recording medium or in separate recording media. Alternatively, the meta data recorder 22 may be a device that records only meta data in a predetermined recording medium.

The system controller 16 and the meta data recorder 22 may not be directly connected together and the system controller 16 may transmit meta data to the meta data recorder 22 via the camera main body 12. The present invention can be applied to this case by changing signal transmissions between the system controller 16 and the meta data recorder 22 to signal transmissions between the system controller 16 and the camera main body 12.

A select switch 34, shown in this figure, is used by the operator to specify the type of the photographing lens 10 in the present system, which uses the system controller 16. For example, when the select switch 34 is used to select a desired number from 0, 1, 2, . . . to N, the CPU 30 recognizes the photographing lens of the type pre-associated with the selected number is being used as the photographing lens 10 in the present system. However, if the select switch 34 is used to select a particular number, for example, zero, the specification of the type of the photographing lens 10 using the select switch 34 is invalid.

A ROM (not shown) built into the CPU 30 stores inherent data in association with photographing lenses of types that can be specified using the select switch 34. The inherent data is used to control the focus lens, zoom lens, and iris of the photographing lens 10 and to execute a process adapted to the characteristics, performance, and the like of the photographing lens 10 when meta data is generated.

Specifically, the numerical range of the output value from the potentiometer detecting the position of the focus lens, zoom lens, or iris within its movable range varies depending on the type of the photographing lens 10. Further, even though the output values from the potentiometers remain unchanged, an optical state varies depending on the type of the photographing lens 10. The CPU 30 uses a predetermined program to control the positions and operating speeds of the focus lens, zoom lens, and iris with reference to the output values from the corresponding potentiometers. In this case, when a process of determining the position or operating speed is executed using the same program regardless of the type of the photographing lens 10, the process is not adapted to the characteristics and performance of the photographing lens 10. For example, when the position of the focus lens is controlled so that the output value from the potentiometer is constant at a certain value in the instruction signal (position instruction signal) outputted by the focus controller 18 regardless of the type of the photographing lens 10, the movable range of the focus lens does not correspond appropriately to the operational range of the operation member for the focus controller 18. Further, if the program remains unchanged, it is impossible to appropriately execute a process of forcedly reducing the movement speed of the focus lens when the focus lens nears a mechanical limited end and stopping the focus lens when it reaches the limited end. This is because the output value from the potentiometer at the limited end varies depending on the type of the photographing lens 10. Furthermore, if the program remains unchanged, it is impossible to appropriately execute a process of varying the operating sensitivity of the focus controller 18 or zoom controller 20 depending on the position of the focus lens or zoom lens.

Thus, for example, parameters used in the program vary depending on the type of the photographing lens 10. The inherent data can then be used to set appropriate parameter values so as to control the focus lens, the zoom lens, or the iris depending on the type of the photographing lens 10. The inherent data is not parameter values used in the program but may be a program itself executed in association with the type of the photographing lens 10, or in another form.

The inherent data includes those used to generate the meta data indicative of the set conditions for the photographing lens 10, such as the lens-to-subject distance, focal distance, and iris value of the photographing lens 10. That is, the relationship between the output values from the potentiometers detecting the positions of the focus lens, zoom lens, and iris and the lens-to-subject distance, focal distance, or iris value determined from the output values varies depending on the type of the photographing lens. Thus, the inherent data is set to determine the correct lens-to-subject distance, focal distance, and iris value from the output values from the potentiometers in accordance with the type of the photographing lens 10. In the present embodiment, the inherent data is graph data in which the output values from the potentiometers are associated with the current lens-to-subject distance, focal distance, and iris value. The inherent data may be the values of calculation parameters used to calculate meta data such as the focal distance from the output values from the potentiometers, or may be in another form.

If the select switch 34 is used to specify a number other than zero, which invalidates the specification, the CPU 30 reads the inherent data corresponding to the type of the photographing lens 10 specified by the number from the ROM. On the basis of the inherent data, the CPU 30 executes a process of controlling the focus lens, the zoom lens, and the iris or generating meta data. If the select switch 34 is used to specify zero, the CPU 30 uses the inherent data on the last photographing lens 10 used.

On the other hand, by connecting the PC 24 to the terminal 16H of the system controller 16, it is possible to use the PC 24 to specify the type of the photographing lens 10 in the present system, which uses the system controller 16, or to set the inherent data for the photographing lens. The SCI can be used to transmit various signals between the PC 24 connected to the terminal 16H and the CPU 30. If the PC 24 is connected to the system controller 24, the CPU 30 receives the specified type of the photographing lens 10 from the PC 24. If the inherent data corresponding to the specified type of the photographing lens is recorded in the ROM or an EEPROM 36 that stores previously used inherent data, the CPU 30 uses this inherent data. On the other hand, the inherent data corresponding to the specified type of the photographing lens is not recorded in the ROM, the CPU 30 also acquires this inherent data from the PC 24 and stores it in the EEPROM 36. The CPU 30 then executes a process using the inherent data stored in the EEPROM 36.

A switch S1, shown in the figure, is used to instruct the CPU 30 to re-set the type of the photographing lens and the inherent data if the photographing lens 10 has been replaced with another type of photographing lens without turning off the power supply of the system (the power supply to the camera main body 12, the system controller 16, and the like). This switch serves to reduce the time and effort required to reactivate the system when the photographing lens is replaced with a different one. Instead of the switch S1, the PC 24 may instruct the CPU 30 to re-set the type of the photographing lens and the inherent data.

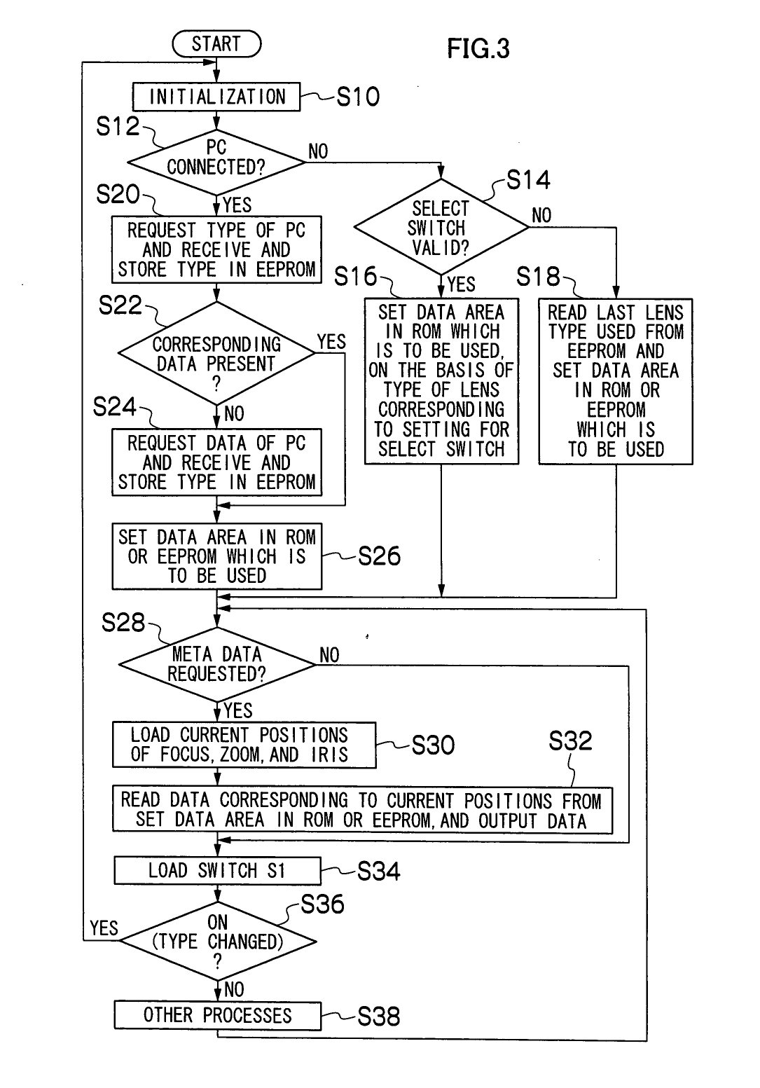

FIG. 3 is a flow chart showing a process procedure executed by the CPU 30 of the system controller 16. The flow chart shows a process relating mainly to the generation of meta data. When the power supply is turned on, the CPU 30 carries out required initializations (step S10). Then, the CPU 30 determines whether or not the PC 24 is connected (step S12). If the CPU 30 determines that the PC 24 is not connected, it then determines whether or not the select switch 34 is valid, that is, the select switch 34 indicates a number other than zero (step S14). If the CPU 30 determines that the select switch 34 is valid (not zero), then on the basis of the type of the photographing lens corresponding to the number specified by the select switch 34, a data area (address) in the ROM in which the meta data corresponding to this type is set as a data area in the ROM which is used to generate meta data (step S16). On the other hand, if the CPU 30 determines in the step S14 that the select switch 34 indicates zero, the CPU 30 reads the last type of the photographing lens used from the EEPROM 36. The CPU 30 then sets a data area (address) in the ROM or EEPROM 36 in which the inherent data corresponding to this type is set as a data area in the ROM or EEPROM 36 which is used to generate meta data (step S18). After the step 16 or 18, the procedure shifts to a step S28, described later.

On the other hand, if the result of the determination in step S12 is affirmative, that is, the CPU 30 determines that the PC 24 is connected, the CPU 30 then requests the PC 24 to transmit the type of the photographing lens 10. Then, the PC 24 transmits the type of the photographing lens 10 specified by the operator. Upon receiving this information, the CPU 30 stores the type of the photographing lens 10 in the EEPROM 36 (step S20).

Then, the CPU 30 determines whether or not the inherent data corresponding to the type of the photographing lens 10 specified by the PC 24 is recorded in the ROM or the EEPROM 36 (step S22). If the CPU 30 determines that the inherent data is not recorded in the ROM or the EEPROM 36, it requests the PC 24 to transmit the inherent data corresponding to the type of the photographing lens 10 specified by the PC 24. The CPU 30 then receives the inherent data from the PC 24 and records it in the EEPROM 36 (step S24). The CPU 30 then sets the data area in the EEPROM 36 in which the inherent data is recorded, as a data area in the EEPROM 36 which is used to generate meta data (step S26). On the other hand, if the CPU 30 determines in the step S22 that the inherent data is recorded in the ROM or the EEPROM 36, it does not request the PC 24 to transmit the inherent data. The CPU 30 then sets a data area in the ROM or EEPROM 36 in which the inherent data corresponding to the specified type of the photographing lens 10, as a data area in the ROM or EEPROM 36 which is used to generate meta data (step S26).

After the step S16, S18, or S26, the CPU 30 determines whether or not the meta data recorder 22 is requesting transmission of meta data (step S28). It the CPU 30 determines that the meta data recorder 22 is requesting transmission of meta data, it loads the output values from the potentiometers of the drive units 14A to 14C into itself as information on the current positions of the focus (focus lens), zoom (zoom lens), and iris (step S30) of the photographing lens.

Subsequently, the CPU 30 reads the meta data corresponding to the output values (current positions) from the potentiometers, from the data area in the ROM or EEPROM 36 set in the step S16, S18, or S26. The CPU 30 then outputs the meta data to the meta data recorder 22 (step S32). In the present embodiment, the inherent data comprises the output values from the potentiometers in association with the meta data indicative of the lens-to-subject distance, focal distance, and iris value at these output values.

After the step S32 or if the CPU 30 determines in the step S28 that the meta data recorder 22 is requesting transmission of meta data, the CPU 30 loads the state of the switch S1 into itself (step S34). The CPU 30 then determines whether or not the switch S1 has been turned on (step S36). If the CPU 30 determines that the switch S1 has not been turned on, it executes another process (control of the focus lens or the like). Then, the process is repeated starting with the step S28. On the other hand, if the CPU 30 determines that the switch S1 has been turned on in the step S36, it executes the process again starting with the step S12 to re-set inherent data used to generate meta data.

In the above flow chart, description has been given of the procedure of setting inherent data used to generate meta data. However, the procedure of setting inherent data used to control the focus lens, zoom lens, and iris is similar to that shown in the above flow chart.

The procedure may be properly changed so that types of the photographing lens 10 which can be specified using the select switch 34 as well as their inherent data can be transmitted from the PC 24 to the system controller 16 and then written in the memory such as the EEPROM.

In the above embodiment, the type of the photographing lens is specified as individuality information specifying the individuality of the photographing lens, and the inherent data corresponding to the type is used. Instead of the type, serial numbers, that is, different numbers assigned to the respective photographing lenses may be specified. In this case, if photographing lenses have different serial numbers but the same type is determined from both serial numbers, then the same inherent data may be used. Further, considering that there may be a difference between different photographing lenses of the same type, the inherent data may be associated with the respective serial numbers.

Now, description will be given of a process of urging the meta data recorder 22 or the camera main body 12 to re-set the type of the photographing lens if the type of the photographing lens 10 has been changed to re-set the type of the photographing lens and its inherent data in the system controller 16. Although not referred to in the above embodiment, the type of the photographing lens 10 set by the select switch 34 or PC 24 is also transmitted to the meta data recorder 22 and the camera main body 12. For example, the meta data recorder 22 records the type of the photographing lens 10 as well as the meta data. During initialization executed when the system is powered on, the meta data recorder 22 and the camera main body 12 request the system controller 16 to transmit the type of the photographing lens 10. The meta data recorder 22 and the camera main body 12 thus receive the type of the photographing lens 10. Further, information such as the type of the photographing lens and meta data is transmitted in response to a request made of the system controller 16 by the meta data recorder 22 or camera main body 12. Accordingly, even if the type of the photographing lens is changed in the system controller 16 after initialization, it is not changed in the meta data recorder 22 or the camera main body 12. Consequently, the type different from the actual one may disadvantageously be recorded together with meta data.

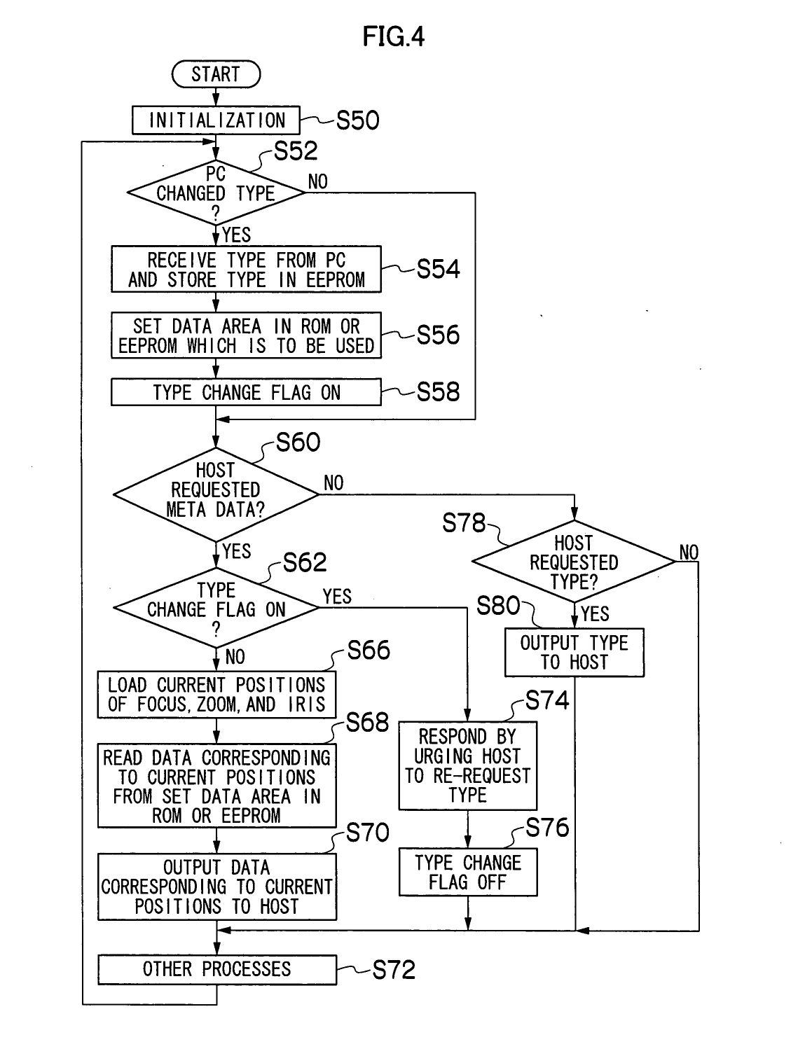

To prevent this, the process in the flow chart shown in FIG. 4 can be applied. Equipment such as the meta data recorder 22 or camera main body 12 which requests the system controller 16 to transmit data is called a host. Further, for simplification, the PC 24 is assumed to set the type of the photographing lens for the system controller.

First, the CPU 30 of the system controller 16 carries out required initializations (step S50). The CPU 30 then determines whether or not the PC 24 has instructed on a change in the type of the photographing lens (step S52). If the CPU 30 determines that the PC 24 has instructed on a change in the type of the photographing lens, it receives the type from the PC 24 and stores the type in the EEPROM 36 (step S54). Although not described in detail, the CPU 30 sets a data area in the ROM or EEPROM 36 in which the inherent data corresponding to the type is recorded, as a data area in the ROM or EEPROM 36 which is used to generate meta data (step S56). Then, the CPU 30 turns on a type change flag. If the CPU 30 determines that the PC 24 has not instructed on a change in the type of the photographing lens in the step S52, the process ending with the step S58 is not executed.

Then, the CPU 30 determines whether or not the host has requested transmission of meta data (step S60). If the CPU 30 determines that the host has requested transmission of meta data, it subsequently determines whether or not the type change flag is on (step S62). If the CPU 30 determines that the type change flag is not on, it loads the output values from the potentiometers of the drive units 14A to 14C into itself as information on the current positions of the focus (focus lens), zoom (zoom lens), and iris of the photographing lens 10 (step S66). The CPU 30 then reads the meta data corresponding to the output values from the potentiometers, from the data area in the ROM or EEPROM 36 which is set as a data area used to generate meta data (step S68). The CPU 30 then outputs the meta data to the host (step S70). Subsequently, the CPU 30 executes other processes (step S72) and then repeats the process starting with the step S52.

On the other hand, if the result of the determination in the step S62 is affirmative, that is, the type change flag is on, the CPU 30 urges the host to re-request the type (step S74). The CPU 30 turns off the type change flag (step S76) and then shifts to the step S72.

If the result of the determination in the step S60 is negative, that is, the host is not requesting meta data, the CPU 30 subsequently determines whether or not the host is requesting the type (step S78). After the step S74, the host is requesting the type and the result of the determination in the step S78 is affirmative. If the CPU 30 determines that the host is requesting the type, it transmits the type to the host (step S80) and then shifts to the step S72. If the CPU 30 determines that the host is not requesting the type, it shifts to the step S72 without executing the step S80.

If the above process is executed to change the type (or serial number) of the photographing lens 10, the CPU 30 of the system controller 16 urges the host to request transmission of the type. The CPU 30 can thus change the setting of the type of the photographing lens 10 in the host without turning off the power supply.

1. A lens system comprising:
an accessory which electrically controls a photographing lens of a camera and which executes a process using inherent data inherent in said photographing lens; and
an inherent data setting device which sets, in said accessory, said inherent data used for said photographing lens.

2. The lens system according to claim 1, wherein said accessory uses the inherent data set by said inherent data setting device, to generate meta data indicating set conditions for said photographing lens.

3. The lens system according to claim 1, further comprising: individuality information setting device for setting individuality information specifying the individuality of said photographing lens, in said accessory.

4. The lens system according to claim 1, wherein said accessory pre-stores individuality-wise inherent data corresponding to a plurality of photographing lenses having different individualities, and said inherent data setting device selects the inherent data used for said photographing lens to be controlled, from the individuality-wise inherent data stored in said accessory.

5. The lens system according to claim 4, comprising input device for communicatively inputting inherent data to be stored in said accessory, to said accessory.

6. The lens system according to claim 1, wherein said inherent data setting device comprises input device for communicatively inputting the inherent data used for said photographing lens to said accessory.

7. The lens system according to claim 4, further comprising: individuality information setting device for setting individuality information specifying the individuality of said photographing lens, and said inherent data setting device selects inherent data corresponding to the photographing lens specified by the individuality information, from said individuality-wise inherent data, on the basis of the individuality information set by the individuality information setting device.

8. The lens system according to claim 3, wherein said individuality information is a type or serial number of the photographing lens.

9. The lens system according to claim 3, wherein said accessory transmits the individuality information set by said individuality information setting device to a communicatively connected predetermined processing device in response to a transmission request from the processing device when the processing device is initialized, and if said individuality information setting device changes the individuality information after the initialization, said accessory urges said processing device to request retransmission of the individuality information and retransmits said changed individuality information to said processing device in response to the transmission request.

10. The lens system according to claim 9, wherein said accessory urges the processing device to request retransmission of said individuality information by causing an error in communication with said processing device.

11. The lens system according to claim 9, wherein said processing device is said camera, or a meta data recording device in which meta data is recorded, the meta data being generated using the inherent data set by said inherent data setting device and indicating the set conditions for said photographing lens.
